(19) United States
(12) Patent Application Publication
(10) Pub. No.: US 2012/0151040 A1
(43) Pub. Date: Jun. 14, 2012

(54) COMPUTER INVENTORY DATA CONSOLIDATION

(76) Inventors: Sergei MOURAVYOV, La Jolla, CA (US); Brindusa Maria Kevorkian, (US)

(21) Appl. No.: 12/966,643

(22) Filed: Dec. 13, 2010

(51) Int. Cl. G06F 15/173

(52) U.S. Cl. 709/224

(57) ABSTRACT

Remaining trust levels (RTLs) are computed for respective computer-inventory data sets. The computations involve applying decay formulae to initially assigned trust levels (ATLs). The data sets can then be consolidated so as to reconcile apparently inconsistent data by comparing respective RTLs.

### BACKGROUND

Managing a computer network can involve maintaining an inventory of network nodes and their configurations. For example, a computer network can include computers, devices hosted by computers, external storage devices, network infrastructure devices, and peripherals. Virtualization technology allows computer networks to include virtual machines, logical storage units, virtual devices, etc. Each of the real and virtual entities may have associated configuration or other inventory data of interest to computer management as well as to other network nodes.

Inventory data regarding a given node can come from multiple sources. For example, configuration and identity data may be provided in response to a SNMP (Simple Network Management Protocol) query. Also, agent software may collect configuration information from its physical or virtual server host. Each node may collect information regarding other nodes with which it communicates. Network devices, e.g., routers, may collect data regarding the source and destination nodes for the packets it routes. Managing all this inventory available from such disparate sources can be a challenge.

### BRIEF DESCRIPTION OF THE DRAWINGS

FIG. 1 is a schematic diagram of a system in accordance with an embodiment.

FIG. 2 is a flow chart of a method in accordance with an embodiment.

FIG. 3 is a combined diagram and flow chart for a network system in accordance with an embodiment.

FIG. 4 is a schematic diagram of a portion of the network system of FIG. 3.

### DETAILED DESCRIPTION

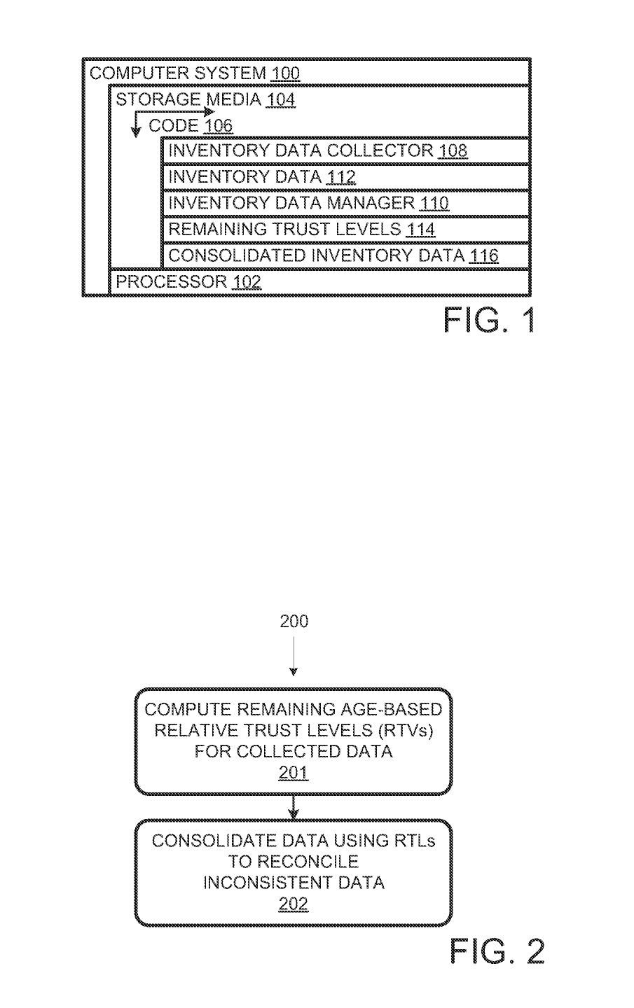

A system 100, shown in FIG. 1, provides for reconciling apparently inconsistent computer inventory data from disparate sources so that the data can be consolidated. Computer system 100 includes a processor 102 and storage media 104. Storage media 104 is encoded with code 106 defining an inventory data collector 108 and an inventory data manager 110. Inventory data collector 108 collects inventory data 112 from disparate sources. Inventory data manager 110: generates remaining (aka “relative”) trust levels (RTLs) 114 for the inventory data; and generates consolidated inventory data 116, using RTLs 114 to reconcile apparent inconsistencies among collected data sets 112.

Inventory data manager 110 and, thus, computer system 100, implement a process 200, flow charted in FIG. 2. At process segment 201, manager 110 computes remaining age-based RTLs 114. This can be done, for example, by time-stamping collected data sets 112 as they are collected and assigning assigned (aka “absolute”) trust levels (ATLs) to inventory data 112. RTLs 114 can be computed based, at least in part, on the ATLs and on the time elapsed since the data was collected. The RTLs then serve as a confidence measure that can be used to prioritize apparently inconsistent data. The inventory data is then consolidated at process segment 202; during consolidation, RTLs are compared and the data with a higher RTL is adopted as part of the consolidated inventory data to the exclusion of apparently inconsistent data with a lower RTL. The end result is a consolidated and consistent computer system inventory containing the most trusted data available.

A computer network system 300 includes various types of computer-inventory entities, e.g., discoverable network nodes 301. These include hardware servers 302, e.g., in the form of stand-alone machines, hard partitions, and rack-mount and blade modules. In some cases, e.g., blades and hard partitions, hardware servers may be parts of an independently discoverable multi-server hardware system 304, e.g., a blade system or a partitioned system. A hardware server can be divided into or host virtual servers 306 in the forms of logical partitions and virtual machines.

The hardware and virtual servers provide respective operating system environments for running respective operating systems 308 on which one or more applications 310 can be run. In addition, each server can host one or more inventory collection agents 312, either as part of an operating system or as a separate utility.

Some hardware servers host independently discoverable hosted devices 314, e.g., HBAs (host bus adapters) for connecting a server to a SAN (Storage Array Network) and LOMB (Lights-Out Modules). In addition, external storage devices 316 can be inventoried and provide inventory data. Network infrastructure devices 318, e.g., routers, and peripherals 320, e.g., printers, scanners, modems, can be sources and objects of inventory data.

A central management server (CMS) 322 provides for managing computer network system 300. This managing involves collecting and managing inventory data representing network nodes and their configurations. To this end, CMS 322 includes a processor 324, e.g., a set of CPUs (Central Processing Units), communication devices 326, e.g., NICs (Network Interface Cards), HBAs, and USB (Universal Serial Bus) ports. In addition, CMS 322 includes storage (e.g., disk and solid-state) media 328 encoded with code 330.

Code 330 represents instructions and other data in physical form so that the instructions can be executed and the data can be read and manipulated by a processor 324. The encoded instructions define an inventory data collector 332 and an inventory data manager 334. In practice, the collector and manager can be integrated into a single program or divided into separate programs. The encoded data includes collected inventory data 335, which can be arranged into sets 336, and consolidated inventory data 338.

Inventory data collector 332 collects data from disparate sources including servers 302, multi-server systems 304, virtual servers 306, hosted devices 314, storage devices 316, network infrastructure devices 318 and peripherals 320. In some cases, one source may provide information not available from another source; in other words one source may provide values for a parameter for which the other source does not provide values. In other cases, one source may provide data that appears to be inconsistent with data provided by another source; for example, two sources might provide different values for the same parameter. In some cases, the inconsistencies are less direct, e.g., a first value of a first parameter might not be consistent with a second value of a second parameter because of known relationships between the parameters.

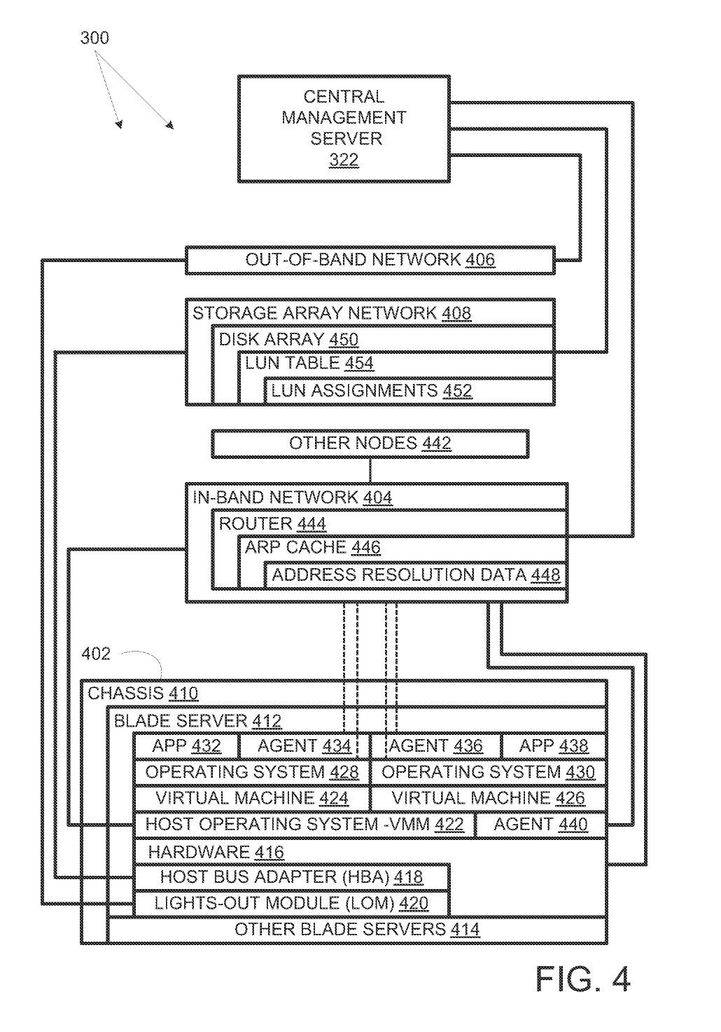

The role of disparate sources for inventory data is demonstrated further with respect to the example of FIG. 4, which depicts particular entities of computer network system 300, e.g., central management server 322, a blade system 402, an in-band network 404, an out-of-band network 406, and a storage array network 408. Blade system 402 includes a chassis 410, a blade server 412, as well as other blade servers 414. Blade server 412 includes hardware 416, including processors, media, and communications devices, the latter including HBA 418 and lights-out module 420.

Blade server 412 can serve as an operating system environment for a host operating system (OS) 422. Host OS 422 can serve as or host a virtual machine monitor. So that virtual machines 424 and 426 can run on blade server 412. Each virtual machine 424, 426 can host its own guest OS 428, 430, respectively. OS 428 can support one or more applications (apps), e.g., application 432, as well, as utilities, in this case including an inventory agent 434. Likewise, OS 430 can support application 436 and inventory agent 438. In addition, host OS 422 can host an inventory agent 440 for blade server 412.

CMS 322 can obtain relatively complete inventory information regarding blade server 412 by communicating with host OS 422 via in-band network 404. For example, CMS 322 can query host OS 422 using an SNMP (Simple Network Management Protocol) protocol. Host OS 422, in its role as a virtual machine monitor, can forward inventory queries and responses to and from virtual machine OSs 428 and 430. Also, agents 434, 438, and 440 can provide inventory data to CMS 422 over in-band network 404. These agents are configured to provide inventory beyond that normally available using SNMP but of interest to some management application, e.g., a management application running on CMS 422.

In-band network 404 provides the primary channels of communications between CMS 322, blade server 412, and other nodes 442. In-band network 404 includes network infrastructure devices such as a router 444. As data is communicated among nodes, router 444 mines data packet headers for information about the sources and destinations of throughgoing packets. For example, address resolution information can be gathered associating IP (Internet Protocol) addresses with MAC (Media Access Code) addresses; router 444 uses packet header information along with calculated statistical data to determine efficient paths for routing data packets.

Router 444 includes an ARP (Address Resolution Protocol) cache 446 for storing the address resolution data 448 obtained from the packets. CMS 322 can access this cache to obtain inventory information regarding network nodes communicating through router 444. As the information in ARP cache 446 may have been collected over a period of time, some of the information may have become obsolete.

CMS 322 can also manage nodes over out-of-band (not normally visible to a managed-node operating system) network 406. Out-of-band network 406 is coupled to servers via integrated lights-out modules, e.g., lights-out module 420. Lights-out modules typically have their own power supplies so that they can provide inventory information even when the host server is shut-down, e.g., to reduce power consumption, for maintenance, or as a result of a failure.

SAN 408 is configured to store data externally relative to servers. In some cases, this is done so that plural servers have convenient access to the externally stored data. In other cases, the data stored is controlled by a single server. For example, overflow data and incremental backup data may be stored externally.

SAN 408 can include multiple arrays, e.g., array 450, of hard disks and solid-state disks for storing server data. A disk array that has more capacity than is needed by any one server can be logically partitioned. Access to a logical partition can be restricted to a single source, e.g., HBA 418, by associating an identifying LUN (logical unit number) of the logical partition (aka, “logical unit”) with an identity, e.g., a WWN (WorldWide Name) of the host HBA or server. In disk array 450, these LUN assignments 452 are stored in a LUN table 454. CMS 322 can access LUN table 454 (as well as LUN tables associated with other disk arrays) to obtain inventory data regarding disk arrays and their hosts.

From the foregoing description referring to FIG. 4, it can be recognized that information regarding blade server 142 can be obtained from disparate sources. These disparate sources can include its lights-out module 420, and other hardware and software components, chassis 140 that hosts blade server 412, network infrastructure devices such as router 444, disk storage devices such as disk array 450, as well as other network nodes.

Information from one source may not be available from another source. Thus, the information available through SNMP queries can be supplemented in different ways, respectively, by information from router 444 and disk array 450. Thus, a more complete representation of system 300 can be obtained than is available from any single source.

Data from disparate sources may overlap, in which case, inconsistencies or at least apparent inconsistencies may occur. While inconsistencies can occur due to errors, the most likely source of an apparent inconsistency is the obsolescence (e.g., as a result of a configuration change) of formerly valid data. For example, blade server 412 may be configured with a new IP address while ARP cache 446 continues to associate that IP address with a former owner.

In some cases, such inconsistencies can be resolved using specific information concerning a reconfiguration. For example, a discrepancy regarding IF addresses might be resolved given knowledge that a virtual machine has been moved from one hardware server to another while retaining its IP address. However, such specific information is not always available. Accordingly, system 300 provides for reconciling inconsistencies using trust (aka confidence) levels. For example, data regarding an inventory entity just generated by the inventory entity itself in response to a query is very likely to be accurate; accordingly, such data could be assigned a high trust level. On the other hand, data collected from storage by a source regarding another inventory entity could be assigned a lower trust level as it may have been stale even when collected by CMS 322. Moreover, the confidence level for data collected by CMS 322 may be reduced as it ages.

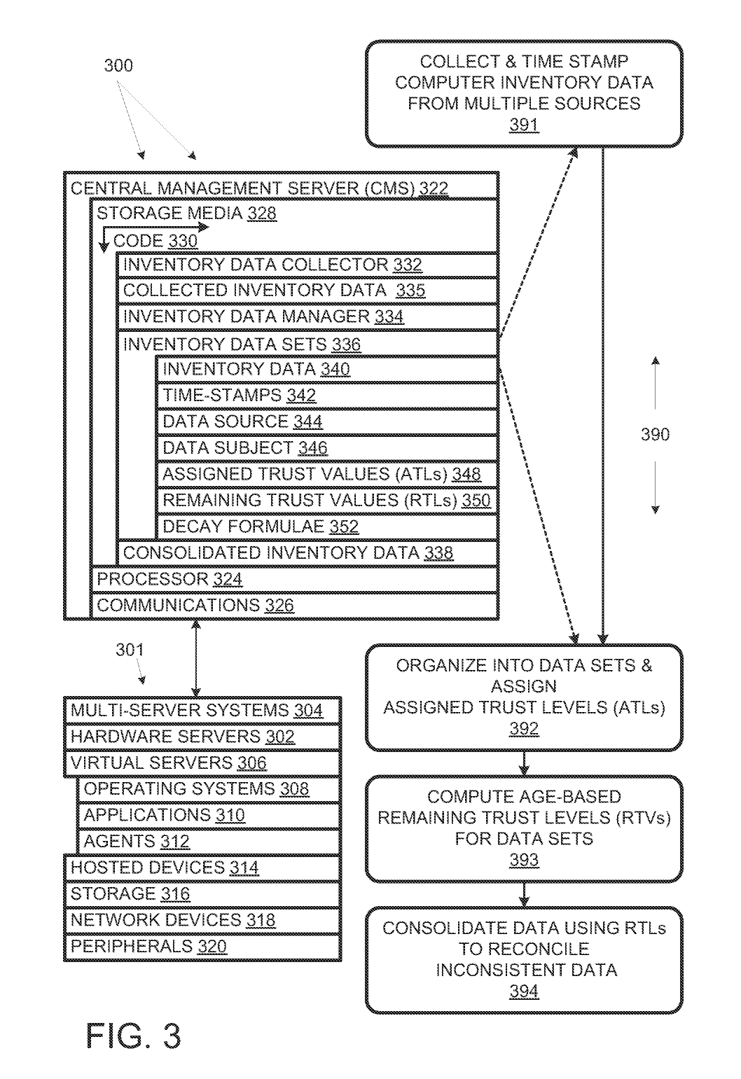

Accordingly, CMS 322 implements a process 390, flow charted in FIG. 3. At process segment 391, inventory data collector 332 collects inventory data 335 from disparate sources. Depending on the source and nature of the data sought, the collections can be periodic or occasional. Data is time-stamped as it is received.

At process segment 392, inventory data manager 334 organizes collected data into sets and assigns assigned trust levels ATLs 348 to the sets. Manager 334 provides for various finer and coarser assignments of ATLs to data, and the sets can be selected to match the fineness of the assignments. For example, an ATL can be assigned to a set consisting of all data collected from a particular source at a particular time. However, these sets can be divided according to the subject of the data, with ATLs being assigned as a function of both source and subject. Furthermore, manager 332 provides for assigning ATLs to sets consisting of individual items of data. Thus, as a result of process segment 392, collected inventory data sets 336 include inventory data 340 associated with time stamps 342, data sources 344, data subjects 346, and ATLs 348.

At process segment 393, inventory data manager 334 computes age-based remaining trust levels RTLs 350 for the data sets. As collected data ages, the likelihood of its being obsolete increases. This reality is reflected in RTLs that are initially equal to the ATLs, but decay over time. Manager 334 computes RTLs based on formulas 352 that, like the ATLs, can vary by data set. For example, a linear formula template can be of the form. RTL=ATL*(1−et/lt), where it is an assigned useful lifetime for data and et is the elapsed time since the time indicated in the respective time stamp. Alternatively, non-linear formulas, including stepped and exponential formulas (in which case, half-lives might be used instead of full lifetimes) and formulae can take additional factors into account.

Appropriate ATLs and formulae are system dependent. Accordingly, while default ATLs and formulae may be provided, it is anticipated that they may be adjusted empirically. For example, the validity of data can be evaluated as it is collected and as it ages under controlled circumstances so that the actual values corresponding to the inventory data are known. Under these conditions, ATLs 348 and decay formulae 352 can be refined.

At process segment 394, inventory data manager 334 consolidates inventory data to yield consolidated inventory data 338. This may involve generating new consolidated data or updating existing consolidated data. Data missing from one data set can be filled in using data from other data sets. Apparent inconsistencies are resolved by comparing RTLs. The inconsistent data with the higher or highest RTL is included in consolidated data 338. Data associated with a lower RTL may be omitted from consolidated data 338.

The lower-RTL data may be retained as part of collected inventory data sets 336. Initially lower RTL data with a long lifetime will decay more slowly than initially higher RTL data with a short lifetime. In such cases, the initially higher RTL may fall below the initially lower RTL, causing a role reversal in the next consolidation. Depending on the configuration, data sets, e.g., those associated with workstations, laptops or virtual devices, with RTLs equal to zero or below can be purged as obsolete or likely to be incorrect.

In some other cases, even though the RTL is beyond its lifespan, it can still be retained and used with the lowest priority during a reconciliation process. This can be a case in which a network administrator has turned off SNMP access to a gateway that was previously inventoried over SNMP. As long the device is seen alive on the network, e.g. responds to ICMP ping requests or if other minimal up-to-date inventory information can be gathered from other sources (ARP or bridge caches of switches, CDP protocol, etc.), it can be assumed that the device's inventory is likely unchanged.

Some data sets can be purged even before their RTL reaches zero. This may happen if the data in this data set is completely inconsistent with other data sets coming in. For example, data associated with installed operating-systems, CPUs, disk, NIC information or the like frequently conflicts with other incoming data sets, e.g., when a virtual machine is fully reconfigured.

The lifespan of a particular data set can be assigned based on the inventory frequency. If the SNMP-inventory cycle is one week, the life span can be one-and-a-half or two weeks; if the scanning frequency is one month, the life span of the scan-dataset can be set to a month-and-a-half. If inventory data sets are not updated on a regular basis, they may be trashed. If all of the data sets for a particular node are trashed, the all data regarding the node itself may be trashed.

if the inventory source (e.g. Virtual Machine host) is accessible but the inventory data of a particular device (e.g. hosted Virtual Machine) is missing, the latter device (Virtual Machine) can be deactivated (marked as not active on the network). This signifies that some kind of move/purge event happened. Accordingly, the virtual machine is marked as not active until other inventory data locates it. If updated inventory data does not appear, then all the virtual-machine's inventory data is trashed when all of its dataset-lifespans expire.

Herein, “process” is limited to processes qualifying as statutory subject matter under 35 U.S.C. 101 and inherently involves a physical transformation. Herein, a “computer-implemented process” is a process tied to a particular machine. Herein, “computing” means “calculating using computer hardware.”

Herein, a “computer network system” is a system including one or more networks including computers, e.g., hardware servers. A computer network system may include other components as well, including software components, hosted devices, external storage devices, network infrastructure devices, peripherals, etc.

Herein, “inventory” is interpreted in the context of a computer network system to refer to the hardware and software components of the system. “Inventory data” encompasses the identities of the network system components and their configurations. “Configuration” is defined broadly to encompass the full range of uses of the term in the computer arts. For example, “configuration data” can include a list of components of a hardware server, hardwired and configurable identities and addresses (e.g., IP addresses), installed software and settings, firmware versions, etc.

Herein, a “trust level” is a measure of the estimated likelihood that associated data is (remains) valid. “ATL” refers to “assigned trust level” or “absolute trust level”. In either case, an AIL is a trust level assigned to a data set to indicate the likelihood of its validity at the time it is collected, e.g., as indicated by a time stamp. Herein, a “time stamp” is time data indicated the absolute time of an event, in this case, the time data is collected. “RTL” stands for “remaining trust level” or “relative trust level”. In either case, RTL indicates the trust level of collected time at a time that may be after the time the data was collected. In general, an RTL can be computed by applying a decay formula to the respective ATL and a lapsed time since the data was collected. A “decay formula” is a monotonically decreasing (or non-increasing) function of time (provided other factors, if any, are held constant).

“Disparate” herein refers to a plurality including distinct types. “To consolidate” and related terms refer to combining data to yield a single consistent whole, e.g., a consistent overview of a computer network system. “Apparently inconsistent data” refers to data that is inconsistent or appears to be inconsistent (e.g., because some information required to explain a difference is not currently available). “Reconcile” means resolving apparent inconsistencies, e.g., by selecting data with a higher RTL over data with a lower RIM for inclusion in consolidated data.

Herein, a “system” is a set of interacting elements, wherein the elements can be, by way of example and not of limitation, mechanical components, electrical elements, atoms, instructions encoded in storage media, and process segments. “Device” and “machine” imply hardware unless they are explicitly described as “virtual” or “logical”. Herein, “storage media” is inherently non-transitory and tangible. Herein, a “processor” is a set of CPUs, e.g., one or more integrated circuits with conductive material useful for manipulating tangible representations of data in accordance with tangible representations of instructions. Herein, “data collector” and “data manager” refer to components of a computer system including software programs and the hardware required to execute those programs.

In this specification, related art is discussed for expository purposes. Related art labeled “prior art”, if any, is admitted prior art. Related art not labeled “prior art” is not admitted prior art. The embodiments described above and depicted in the referenced figures are presented as non-limiting examples. The illustrated and other described embodiments, as well as modifications thereto and variations thereupon are within the scope of the following claims.

What is claimed is:

1. A computer-implemented process comprising:
computing remaining trust levels (RTLs) for computer-inventory data by applying decay formulae to initially assigned trust levels (ATLs); and
consolidating said inventory data to yield consolidated data said consolidating involving reconciling apparently inconsistent data by comparing their respective RTLs.

2. A process as recited in claim 1 further comprising:
collecting and time-stamping inventory data from disparate sources including a hardware servers.

3. A process as recited in claim 1 wherein:
a first of said data sets includes data collected from said hardware server representing a configuration of said hardware server; and
a second of said data sets includes data collected from an external source external to said hardware server and representing at least part of a configuration of said hardware server.

4. A process as recited in claim 3 further comprising: organizing said inventory data into sets as it is collected; and assigning ATLs to said sets.

5. A process as recited in claim 3 wherein each of said data sets includes different data items collected in the same time interval from the same source.

6. A process as recited in claim 5 wherein each of said data sets includes different data items representing respectively different aspects of the configuration of a common inventory entity.

7. A system comprising:
an inventory data collector configured to collect computer-inventory data over one or more networks from network nodes of disparate types, said inventory data representing at least aspects of configurations of said nodes; and
an inventory data manager configured to:
organize said inventory data into inventory data sets,
compute respective remaining trust levels (RTLs) for said data sets; and
consolidate said inventory data using said RTLs to reconcile inconsistent data to yield consolidated inventory data.

8. A system as recited in claim 7 further comprising:
computer-readable storage media encoded with code defining the functionality of said inventory data collector and said inventory data manager; and
a processor for executing said code.

9. A system as recited in claim 6 wherein:
said inventory data collector is further configured to time-stamp said computer-inventory data; and
said inventory data manager is further configured to assign assigned trust levels (ATLs) to said data sets and compute said RTLs from said ATLs based on respective decay formulas.

10. A system as recited in claim 6 wherein said disparate types include hardware types and virtual types.

11. A system comprising computer-readable storage media encoded with code defining an inventory data manager configured to, when executed by a processor:
compute remaining trust levels (RTLs) for respective computer-inventory data sets of inventory data regarding network nodes by applying decay formulae to initially assigned trust levels (ATLs), said inventory data sets collectively including at least some inventory data representing the configuration of a hardware server (412); and
consolidate said data sets to yield consolidated inventory data, said consolidating involving reconciling apparently inconsistent data based on a comparison of their respective RTLs.

12. A system as recited in claim 11 further comprising said processor.

13. A system as recited in claim 11 wherein said code further defines an inventory data collector configured to, when executed by said processor, collect and time-stamp inventory data from multiple sources.

14. A system as recited in claim 11 wherein said inventory data collector collects said inventory over in-band and out-of-band networks.

15. A system as recited in claim 11 wherein said network inventory data includes address resolution data obtained from a network infrastructure device.
